(19) United States
(12) Patent Application Publication
(10) Pub. No.: US 2005/0030680 A1
(43) Pub. Date: Feb. 10, 2005

(54) Electric outlet for stanby power interruption and power saving, control method thereof, and power saving system

(76) Inventors: Eun-Su Lee, Seoul (KR); Hyun-Soo Kim, Gyeongsangbuk-do (KR)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/495,721

(22) PCT Filed: Aug. 30, 2002
(86) PCT No.: PCT/KR02/01640

(30) Foreign Application Priority Data
Jan. 22, 2002 (KR) 2002/03542
Mar. 25, 2002 (KR) 2002/16080

(51) Int. Cl. H02H 7/00

(52) U.S. Cl. 361/18

(57) ABSTRACT

Disclosed is an electric outlet which comprises: a connector for extracting clock signals and data signals of input devices; a main outlet for supplying AC power to a computer; an auxiliary outlet for supplying AC power to peripheral devices; and a main controller for receiving AC power, supplying the AC power to the main outlet, determining a user's computer using states according to the clock signals and the data signals, interrupting power supply to the auxiliary outlet when the user does not use the computer for a setting time, and starting power supply to the auxiliary outlet when the user uses the computer. The clock and data signals are extracted, and when a user does not use the computer, power supply to the peripheral devices are interrupted, and when the user uses the computer, power supply to the peripheral devices is started thereby reducing power consumption during the pause period.

### BACKGROUND OF THE INVENTION

(a) Field of the Invention

The present invention relates to an electric outlet for a power supply. More specifically, the present invention relates to a computer's electric outlet for supplying power to the computer and its peripheral devices, and completely stopping the power supplied to the peripheral devices when no input signal is provided from input devices including a computer's keyboard or mouse during a predetermined time frame, a control method thereof, and a power-saving system.

(b) Description of the Related Art

In general, as higher computer specifications have been required and the computers have adopted multimedia, many types of peripheral devices have come to be connected to home or office computers. For example, it is very common for a single computer to be connected to a monitor, a set of speakers, a printer, a scanner, and a PC (personal computer) camera. To supply power to the computer and the peripheral devices, multiple electric outlets are used.

However, since the peripheral devices are used only when the computer is in use according to the user's need, if the user does not use the computer, the user is required to turn the respective devices off, for example, in such cases as when the computer is turned off and a plug of the computer remains inserted in the electric outlet (referred to as a ‘standby period’ hereinafter) or when the computer remains turned on but it is not used for a long time (referred to as a ‘pause period’ hereinafter.)

So as to save power during the standby period, a method for installing a manual switch in a multiple electric outlet to control power on/off states, and a method for detecting the current of the power supplied to the computer from a computer electric outlet and interrupting the power supplied to the peripheral devices when the computer is turned off have been disclosed. For example, Korean utility model no. 20-218843 (allowed on Jan. 19, 2001) entitled “Power-saving multiple electric outlet” detects on/off states of a computer through a current detection method, and interrupts power supply to peripheral devices when the computer is turned off.

However, it does not provide for power saving during the pause period, that is, when the computer is not used for a long time when it is turned on. To solve this problem, the current state of the monitor may be switched to a power-saving mode through a computer's software program when the user does not use input devices such as a mouse or a keyboard during an established time period. However, this method only saves power consumed by the monitor when the computer is not used, and it does not interrupt the power supplied to other peripheral devices.

Further, users generally turn electronic home appliances on and off with plugs of the home appliances still inserted into the electric outlets. Since small amounts of power are still consumed in this case, it may add up to a very huge volume of power loss from a nationwide point of view.

### SUMMARY OF THE INVENTION

It is an object of the present invention to provide a computer electric outlet for detecting a user's computer using state from an input device, interrupting the power supply to peripheral devices when the computer is turned on and not being used, and supplying power to the peripheral devices when the user attempts to use the computer to thereby save power consumed by the peripheral devices during the pause period and the standby period, a control method thereof, and a power-saving system.

In one aspect of the present invention, an electric outlet comprises: a connector for extracting clock signals and data signals of a computer input device; a main outlet for supplying AC power to a computer; at least one auxiliary outlet for supplying AC power to at least one computer peripheral device; and a main controller for receiving AC power, supplying the AC power to the main outlet, determining a user's computer using states according to the clock signals and the data signals extracted by the connector, interrupting power supply to the auxiliary outlet when the user does not use the computer for a predetermined setting time, and starting power supply to the auxiliary outlet when the user uses the computer.

In the computer electric outlet according to preferred embodiments of the present invention, clock signals and data signals of a mouse and a keyboard are extracted, and when it is determined that the user does not use the computer, power supply to the peripheral devices are interrupted, and when the user uses again the computer, power supply to the peripheral devices is started so that power consumption by the peripheral devices may be reduced during the pause period.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a block diagram for illustrating connections between an electric outlet and peripheral devices according to a first preferred embodiment of the present invention;

FIG. 2 shows a detailed block diagram of a main controller of FIG. 1;

FIG. 3 shows a flowchart for controlling an electric outlet according to the first preferred embodiment of the present invention;

FIG. 4 shows a schematic diagram of a power-saving system according to a second preferred embodiment of the present invention; and

FIG. 5 shows a flowchart of a control method applied to the power-saving system of FIG. 4.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

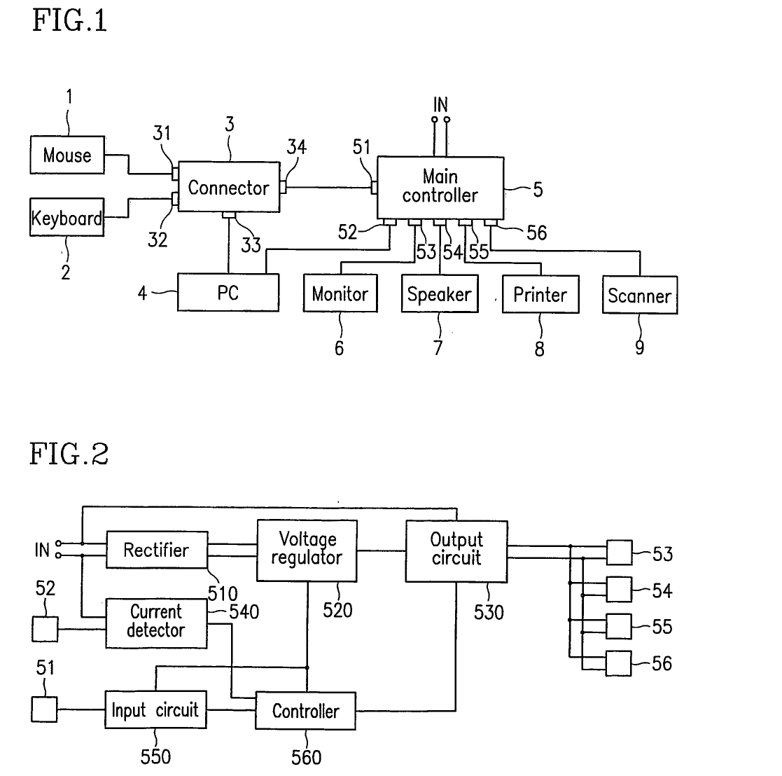

In reference to FIGS. 1 through 3, an electric outlet according to the first preferred embodiment of the present invention will be described.

FIG. 1 shows a block diagram for illustrating connections between an electric outlet and peripheral devices according to a first preferred embodiment of the present invention, and FIG. 2 shows a detailed block diagram of a main controller of FIG. 1.

As shown in FIG. 1, the electric outlet comprises: a connector 3 having a plurality of first through fourth terminals 31, 32, 33, and 34; and a main controller 5 having a main outlet 52 and a plurality of auxiliary outlets 53, 54, 55, and 56.

The connector 3 comprises: a first terminal 31 coupled to a mouse 1; a second terminal 32 coupled to a keyboard 2; a third terminal 33 coupled to a PC 4; and a fourth terminal 34 coupled to the main controller 5. In this instance, the mouse includes a PS/2 mouse, a USB mouse, an optical mouse, and a cordless mouse. The cordless mouse substitutes wire with wireless data communication media. When the cordless mouse is used, a wireless module is installed in the connector 3.

The connector 3 installs a circuit (not illustrated) for connecting signal lines, and the circuit connects the first and second terminals 31 and 32 respectively coupled to the mouse 1 and the keyboard 2 with the third terminal 33 coupled to the PC 4, and it connects a data signal line and a clock signal line from among the signal lines of the mouse 1 and the keyboard 2 with the fourth terminal 34 coupled to the main controller 5, the signal lines being input through the first and second terminals 31 and 32. That is, clock signals and data signals from among signals of the mouse 1 and the keyboard 2 may be output to the electric outlet through the connector 34.

The main controller 5 comprises: a terminal 51 coupled to the connector 3; a main outlet 52 for supplying power to the PC 4; and auxiliary outlets 53, 54, 55, and 56 for supplying power to peripheral devices including a monitor 6, a speaker 7, a printer, and a scanner 9. Also, the main controller 5 receives AC power through an input terminal IN. In this instance, AC power is directly supplied to the main outlet 52, and it is also supplied to the auxiliary outlets 53, 54, 55, and 56 via an output circuit having turn-on/off functions. Therefore, the AC power is supplied to the auxiliary outlets 53, 54, 55, and 56 or it is interrupted according to the on/off states of the output circuit.

The main controller 5 checks whether a user uses the computer through the clock signals and the data signals of the mouse 1 or the keyboard 2 provided through the connector 34, and when it is determined that the user does not use an input device for a predetermined time, the main controller 5 interrupts the AC power supply to the auxiliary outlets 53, 54, 55, and 56. When it is determined that the user uses an input device, the main controller 5 starts supplying the AC power to the auxiliary outlets 53, 54, 55, and 56. Through this process, power supply to the peripheral devices coupled to the PC 4 is interrupted during the pause period of the PC 4.

Referring to FIG. 2, an operation of the main controller 5 will now be described in detail.

As shown, the main controller 5 comprises: a rectifier 510 coupled to the input terminal IN; a voltage regulator 520 and an output circuit 530 coupled to output terminals of the rectifier 510; a current detector 540 coupled between the input terminal IN and the main outlet 52; an input circuit 550 coupled to the terminal 51 for receiving signals of the connector 34; and a controller 560 for receiving output signals from the input circuit and the current detector 540, and generating signals for controlling the output circuit 530. The output circuit 530 is coupled to the four auxiliary outlets 53, 54, 55, and 56 in parallel so that the AC power of the input terminal IN is supplied to the auxiliary outlets 53, 54, 55, and 56 or it is interrupted according to on/off states of the output circuit 530.

The rectifier 510 converts the AC power supplied through the input terminal IN into DC power and supplies the DC power to the voltage regulator 520. The voltage regulator 520 uses the output of the rectifier 510 to generate an operation voltage required for respective circuits, and supplies the generated operation voltage to the input circuit 550, the output circuit 530, and the controller 560.

The current detector 540 detects the current of the AC power supplied through the input terminal IN, and supplies the AC power at the input terminal IN to the main outlet 52. The current detector 540 may be realized using a general transformer. The current detector 540 detects a predetermined current when the PC 4 is in use, and it detects a current very close to zero when the PC 4 is not in use. Therefore, the controller 560 determines power on/off states of the PC 4 according to the current detected by the current detector 540.

The input circuit 550 receives data signals and clock signals of the mouse 1 or the keyboard 2 through the terminal 51 coupled to the connector 3 as shown in FIG. 1, and provides the data signals and the clock signals to the controller 560. The controller 560 uses the data signals and the clock signals to determine using states of the PC 4. If the user does not use the PC temporarily, no clock signal and data signal are generated from the mouse 1 or the keyboard 2, and accordingly, the controller 560 detects the PC using status.

The controller 560 outputs a signal for controlling the on/off states of the output circuit 530 on the basis of the determination on the PC using status. The controller 560 may be realized using a microprocessor, and the output circuit 530 may be implemented utilizing a relay element. The output circuit 530 supplies the AC power at the input terminal IN to the auxiliary outlets 53, 54, 55, and 56 or interrupts the AC power according to on/off states of the output circuit 530.

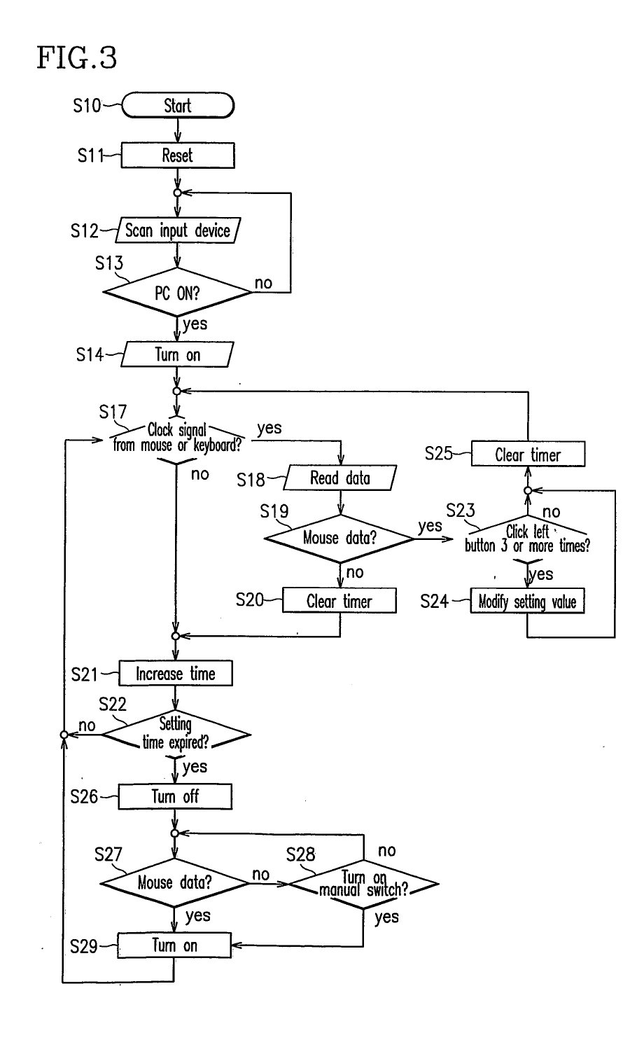

With reference to FIG. 3, an electric outlet control method performed by the controller 560 will now be described.

When the operation of the controller 560 is started in step S10, variables and registers internally used by the controller 560 are initialized to fit an initial condition in step S11.

To determine the PC's turned-on states, the current supplied to the main outlet 52 from the input terminal IN is detected, or information on an input device for checking initialization signals of the mouse 1 and the keyboard 2 is scanned in step S12. It is determined in step S13 whether the PC is turned on based on the above process, and when the PC is found to be not turned on, it goes to the previous step S12. When the PC is found to be turned on, power is supplied to the auxiliary outlets to thereby turn the peripheral devices on in step S14.

It is determined in step S17 whether clock signals are generated from the mouse 1 or the keyboard 2. In the steps S19, S23, and S27 of FIG. 3 according to the preferred embodiment of the present invention, it is described that the signals of the mouse 1 are used, which is only for ease of description, and further, the signals of the keyboard 2 may also be identically used. When the clock signals of the mouse 1 or the keyboard 2 are found to be generated in the step S17, the data signals of the mouse 1 are read in step S18 to determine whether data signals are generated in step S19. When the data signals are not generated in the previous step S19, a timer is cleared in step S20, the time of the timer is increased in step S21, and it is determined in step S22 whether a setting time is expired. When the setting time is expired, power supply to the auxiliary outlets is interrupted to turn the peripheral devices off in step S26. When the setting time is not expired, it goes to the step S17.

The setting time is preset, and it may also be modified by the user. For example, in the case the user does not use the mouse 1 or the keyboard 2, but uses a printer or a scanner for a long time, it is required to modify the setting time because power supply to the peripheral devices must be maintained even when the mouse 1 or the keyboard 2 does not generate data signals. To realize this function, the setting time may be varied in the process of steps S23 through S25. That is, when the data signals of the mouse 1 are being generated in the previous step S19, it is determined in step S23 whether a left button of the mouse 1 is clicked three or more times. The clicking number and the use of the left button is preset and may also be adjusted. For example, the user may preset to click the left button five times so as to change the setting time. When the left button of the mouse 1 is clicked three or more times in the previous step S23, a setting time value is modified in step S24, and when it is clicked less than three times, the timer is cleared in step S25, and it goes to the previous step S17. In this instance, the timer is cleared because the data signals of the mouse are generated which represents a normal PC operation state.

When the user again uses the mouse 1 or the keyboard 2 after the peripheral devices are turned off in the previous step S26, it is required to supply power to the peripheral devices. The process of steps S27 through S29 realizes this function. That is, it is determined whether data signals of the mouse or the keyboard 2 are generated in step S27, and when the data are found to be generated, power is supplied to the auxiliary outlets to turn the peripheral devices on in step S29. When the data are not generated, it is determined in step S28 whether a manual switch (not illustrated) is turned on, and when the manual switched is found to be turned on, the process of the step S29 is performed. The manual switch for the user to forcibly supply power to the auxiliary outlets may be added between the input terminal IN and the auxiliary outlets. The manual switch is similar to general multiple power switches in its concept.

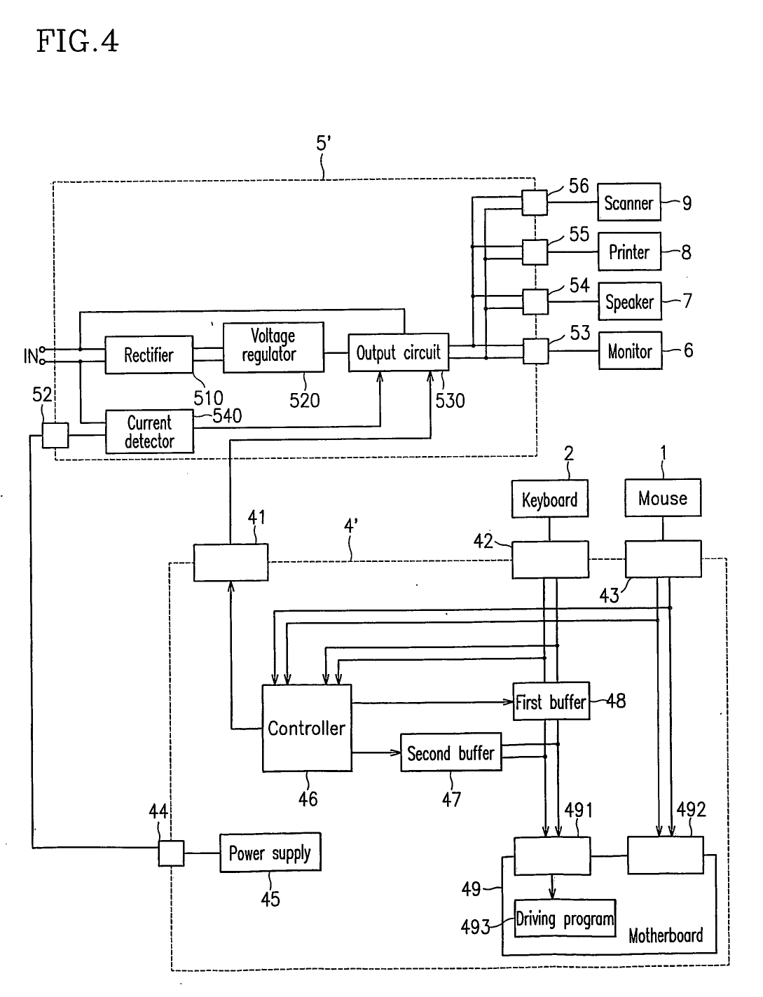

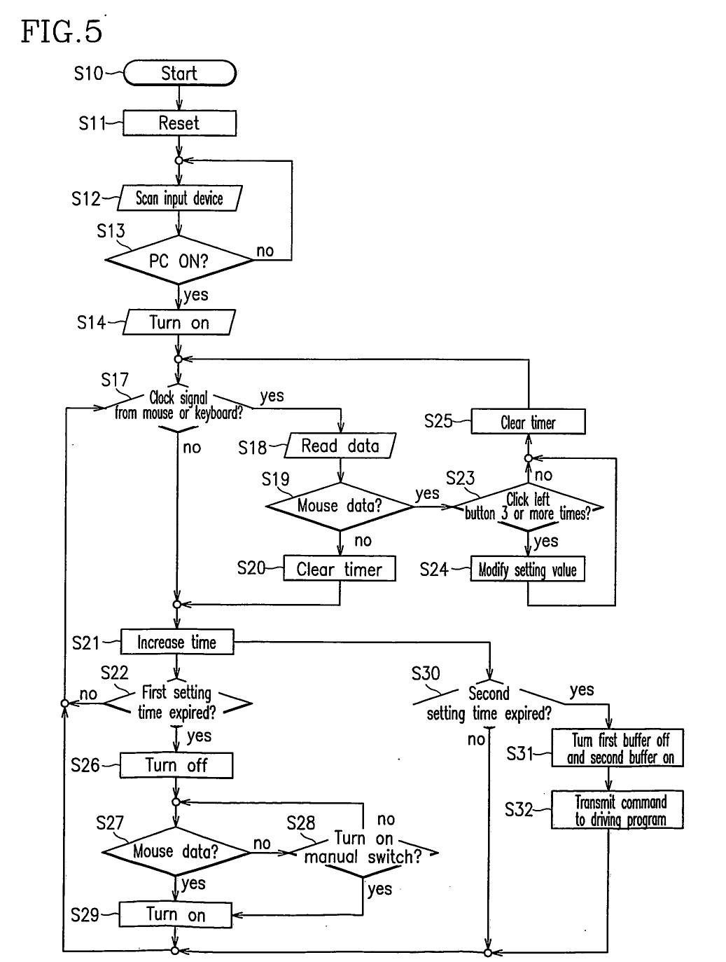

Referring to FIGS. 4 and 5, a power saving system and a control method thereof according to a second preferred embodiment of the present invention will be described.

The power saving system according to the second preferred embodiment of the present invention provides the controller according to the first preferred embodiment of the present invention in the PC, and hence the connector according to the first preferred embodiment of the present invention may be removed, thereby making the system configuration simpler.

As shown in FIG. 4, the power saving system comprises an input device including a mouse 1 and a keyboard 2; a PC 4′; a main controller 5′; and peripheral devices including a monitor 6, a speaker 7, a printer 8, and a scanner 9. When the components of FIG. 4 are the same as those of FIGS. 1 and 2, they have identical reference numerals.

The configuration according to the second preferred embodiment of the present invention is different from that according to the first preferred embodiment of the present invention in that the main controller 5′ omits the input circuit and the controller, and output signals of the current detector 540 are supplied to the output circuit 530. Also, differing from the first preferred embodiment of the present invention, the controller 46 according to the second preferred embodiment of the present invention installed in the PC 4′ monitors input signals of the mouse 1 and the keyboard 2, and when no inputs are provided from the user for a predetermined time frame, the controller 46 drives a driving program 493 provided to a motherboard 49 and an output circuit of the main controller 5′.

The main outlet 52 of the main controller 5′ is coupled via a power cable to a plug 44 installed in a power supply 45 of the PC 4′. The reference numerals 41, 42, and 43 represent ports installed in the PC 4′. The output signals of the controller 46 are transmitted to the output circuit 530 of the main controller 5′ through a port 41, and the ports 42 and 43 transmit the signals input from the keyboard 2 and the mouse 1 to the motherboard 49 of the PC 4′. Terminals 491 and 492 for respectively receiving signals from the keyboard 2 and the mouse 1 are formed on the motherboard 49, and the driving program 493 is coupled to the terminal 491. In a signal input path of the keyboard 2, a first buffer 48 couples the port 42 and the terminal 491, and a second buffer 47 for receiving signals from the controller 46 is provided between the first buffer 48 and the terminal 491. The controller 46 controls the first buffer 48 and the second buffer 47. The signals of the ports 42 and 43 may be input to the controller 46.

When power is supplied to start the operation, the first buffer 48 is in an On state, and the second buffer 47 is in an Off state, and accordingly, the signals of the mouse 1 and the keyboard 2 are normally supplied to the motherboard 49. The controller 46 monitors the signals input from the mouse 1 and the keyboard 2. When no inputs are provided from the mouse 1 or the keyboard 2 for a predetermined setting time, the controller 46 turns the first buffer 48 off, and the second buffer 47 on, and transmits a command for executing the driving program 493 through the second buffer 47. When receiving the execution command, the driving program 493 terminates the system of the PC 4′. In further detail, the driving program 493 stores files under the current process as temporary files, and turns off the power supply 45 of the PC 4′. In an identical manner of the first preferred embodiment of the present invention, the controller 46 interrupts power supply to the peripheral devices during the user's pause or in the standby period by controlling the output circuit 530 of the main controller 5′ through the port 41. Since the corresponding detailed control description is identical with that of the first preferred embodiment of the present invention, no further description will be given.

FIG. 5 shows a flowchart of a modified control method for the power saving system according to the second preferred embodiment of the present invention.

The flowchart of FIG. 5 further adds a process for controlling a driving program to that of FIG. 3.

Referring to FIG. 5, two setting times are provided, that is, a first setting time for determining turned-off states of the peripheral devices, and a second setting time for determining turned-off states of the PC. Further, additional steps S30 through S32 are provided to the flowchart of FIG. 5, differing from the flowchart of FIG. 3.

The added portions will now be described below. It is determined in step S30 whether a predetermined second setting time is expired after the step S21 of FIG. 3 is performed. That is, when it is determined that the second setting time is expired after a clock signal of the mouse 1 or the keyboard 2 is input, the controller 46 turns the first buffer 48 off and the second buffer 47 on in step S31. The controller 46 transmits a command to the driving program 493 through the second buffer 47 to execute the driving program in step S32. The PC 4′ is turned off according to the driving program 493.

As described above, according to the computer electric outlet, a control method thereof, and a power saving system, in order to prevent unnecessary power loss caused by a monitor, a scanner, and a printer during a pause period while a user turns on the computer but does not use it, clock signals and data signals of a mouse and a keyboard are extracted, and when it is determined that the user does not use the computer, power supply to the peripheral devices is interrupted. When the user again uses the computer, power supply to the peripheral devices is reestablishedso that power consumption by the peripheral devices may be reduced during the pause period.

In the case the electric outlet and the corresponding control method according to the preferred embodiments of the present invention are practically applied to computers, about 20 hours of power a day at home and 12 hours of power a day in the office may be saved during the pause period, and in addition, assuming that the computer using time in the office is 12 hours, about 6 hours of power during the pause period may be saved during the day.

While this invention has been described in connection with what is presently considered to be the most practical and preferred embodiment, it is to be understood that the invention is not limited to the disclosed embodiments, but, on the contrary, is intended to cover various modifications and, equivalent arrangements included within the spirit and scope of the appended claims.

1. An electric outlet comprising:
a connector for extracting clock signals and data signals of a computer input device;
a main outlet for supplying AC power to a computer;
at least one auxiliary outlet for supplying AC power to at least one computer peripheral device; and
a main controller for receiving AC power, supplying the AC power to the main outlet, determining a user's computer using state according to the clock signals and the data signals extracted by the connector, interrupting power supply to the auxiliary outlet when the user does not use the computer for a predetermined setting time, and starting power supply to the auxiliary outlet when the user uses the computer.

2. The electric outlet of claim 1, wherein the input device includes a computer's wire or wireless mouse and keyboard.

3. The electric outlet of claim 2, wherein the connector transmits the signals of the mouse and the keyboard to the computer, separates the clock signals and the data signals of the mouse and the keyboard, and provides them to the main controller.

4. The electric outlet of claim 1, wherein the main controller comprises:
a current detector for supplying AC power to the computer, and detecting the current of the AC power supplied to the computer;
a rectifier for converting the AC power into DC power;
a voltage regulator for generating voltage signals used for an internal circuit from the DC power generated by the rectifier;
an input circuit for receiving the clock signals and the data signals from the connector
an output circuit for controlling the AC power supply to the auxiliary outlet; and
a controller for interrupting power supply to the auxiliary outlet when no data signal is generated for a predetermined setting time in the case a clock signal of the input circuit is generated, starting power supply to the auxiliary outlet when a data signal is generated in this case, and in the case no clock signal of the input circuit is generated, determining whether AC power is supplied to the main outlet on the basis of the current of the current detector, and when no power is supplied to the main outlet, interrupting power supply to the auxiliary outlet.

5. A method for controlling an electric outlet, comprising:
(a) resetting internal variables and registers;
(b) turning peripheral devices on when a computer is turned on and input devices are normal;
(c) turning the peripheral devices off when no clock signal of the input devices is generated for a predetermined setting time; and
(d) turning the peripheral devices on when a data signal of the input devices is generated or a manual switch is turned on while the peripheral devices are turned off.

6. The method of claim 5, further comprising: modifying the setting time when a data signal of the input devices is a predefined predetermined code in the case the data signal is generated within the setting time in (c).

7. A power saving system comprising:
a PC (personal computer) including a motherboard for installing a driving program for turning the PC on and off; a first buffer provided on a signal transmission path of a keyboard, for controlling data input states; a second buffer coupled to input data, for controlling data input states instead of the first buffer; and a controller for monitoring input signals of the mouse and the keyboard, turning the first buffer off and the second buffer on when no input signal is provided during a predetermined setting time, and transmitting a command for executing the driving program through the second buffer;
a main outlet for supplying AC power to the PC;
at least one auxiliary outlet for supplying AC power to at least one computer peripheral device; and
a main controller for receiving AC power, supplying the same to the main outlet, and controlling power supply to the auxiliary outlet according to signals provided by the controller of the PC.

8. The system of claim 7, wherein the controller transmits to the main controller a signal for interrupting power supply to the auxiliary outlet when no input is generated from the keyboard or the mouse during a predetermined first setting time, and transmits a command for executing the driving program when no input is generated from the keyboard or the mouse during a second setting time that is longer than the first setting time.

9. The system of claim 7, wherein the main controller comprises:
a current detector for supplying AC power to the PC, and detecting the current of the AC power supplied to the PC;
a rectifier for converting the AC power into DC power;
a voltage regulator for generating voltage signals used for an internal circuit from the DC power generated by the rectifier; and
an output circuit for controlling AC power supply to the auxiliary outlet according to signals output by the controller of the PC.

10. A control method of a power saving system comprising:
(a) resetting internal variables and registers;
(b) turning on peripheral devices when a computer is turned on and input devices are normal;
(c) turning the peripheral devices off when no clock signal of the input devices is generated during a predetermined first setting time;
(d) transmitting a command for executing a driving program for turning a PC off when no clock signal of the input devices is generated during a predetermined second setting time; and
(e) turning the peripheral devices on when a data signal of the input devices is generated or a manual switch is turned on while the peripheral devices are turned off in (c).
